(19) United States
(12) Patent Application Publication
(10) Pub. No.: US 2026/0291374 A1
(43) Pub. Date: Sep. 24, 2026

(54) TRANSIENT OVERVOLTAGE PROTECTION CIRCUIT

(71) Applicant: Caterpillar Inc., Peoria, IL (US)

(72) Inventors: Geoffrey Mart, Chalmers, IN (US); Pratyush Pani, Chennai (IN); Bharadwaj Kaka, Bangalore (IN); Dachuan Yu, Dunlap, IL (US)

(73) Assignee: Caterpillar Inc., Peoria, IL (US)

(21) Appl. No.: 19/084,036

(22) Filed: Mar. 19, 2025

(51) Int. Cl. H02M 1/32

(52) U.S. Cl. CPC H02M 1/32

(57) ABSTRACT

A transient overvoltage protection circuit, for an energy transfer system including inverters having insulated gate bipolar transistor (IGBT)-based circuits, is disclosed. The transient overvoltage protection circuit includes a first surge arrester coupled between a positive DC voltage terminal of an energy transfer system and an electrical ground of the energy transfer system, a second surge arrester coupled between a negative DC voltage terminal of the energy transfer system and the electrical ground, a chopper circuit having a resistor and a thyristor connected in series coupled between the positive DC voltage terminal and the negative DC voltage terminal, and a chopper controller coupled to the positive DC voltage terminal, the negative DC voltage terminal, and the thyristor, the chopper controller configured to activate the chopper circuit based on a differential DC voltage between the positive DC voltage terminal and the negative DC voltage terminal exceeding a junction threshold voltage.

### TECHNICAL FIELD

The present disclosure relates to an overvoltage protection circuit, and more specifically to an overvoltage protection circuit for protecting insulated gate bipolar transistor (IGBT)-based inverters from transient overvoltage caused by connect/disconnect operations of electrical contacts of an electrically powered machine to and from power rails that supply electrical power to the electrically powered machine.

### BACKGROUND

Heavy work machines, such as earth-moving vehicles or hauling trucks, require significant power to carry out their functions. The machines themselves can be of substantial weight, and their loads require large amounts of power to move. Diesel engines traditionally provide that power, but they can have disadvantages. For instance, supplies of diesel fuel may be far away from a haul route or work location.

Electrically powered machines can provide many advantages over diesel machines, but also pose some challenges. The electric engine and components in the work machine require significant electrical power at different voltage levels. For instance, to propel machines along a haul route, an electrical substation may deliver several megawatts at up to 3000VDC through power rails to sliding contactors on the electrically powered machines as the machines move. Onboard batteries may provide electrical power to propel the electrically powered machines outside the haul route and drive ancillary components, but those batteries need to be charged periodically at several megawatts and up to 4800ADC. Balancing these demands presents a challenge for a substation. Additionally, connecting and disconnecting sliding contactors, such as pantograph-type sliding electric contacts, to and from the power rails can cause transient overvoltage, which can damage components connected to the power rails both in the substation powering the electrically power machine and in the electrically powered machine receiving the power.

One arrangement for protecting from overvoltage or surge is described in ES Patent No. 1,003,718 (“the '718 patent”). The '718 patent describes surge protection for a stabilizer including two arresters having a varistor in series with each arrester for protection against overvoltage in a common mode at the inputs of the stabilizer, and a varistor across two outputs for a differential mode. However, among other things, the system of the '718 patent does not specifically address the overvoltage protection requirements for IGBT-based inverters, nor does the disclosed system provide overvoltage protection for the common mode and the differential mode at the same output. As a result, the overvoltage protection system of the '718 patent is limited for IGBT-based inverters.

Examples of the present disclosure are directed to overcoming deficiencies of such systems.

### SUMMARY

In an aspect of the present disclosure, a transient overvoltage protection circuit is provided. The transient overvoltage protection circuit includes a first surge arrester coupled between a positive DC voltage terminal of an energy transfer system and an electrical ground of the energy transfer system, the first surge arrester having a first continuous operating voltage and a first peak voltage, the first peak voltage being a maximum voltage the first surge arrester is capable of tolerating for a first time interval; a second surge arrester coupled between a negative DC voltage terminal of the energy transfer system and the electrical ground, the second surge arrester having a second continuous operating voltage and a second peak voltage, the second peak voltage being a maximum voltage the second surge arrester is capable of tolerating for a second time interval; a chopper circuit coupled between the positive DC voltage terminal and the negative DC voltage terminal, the chopper circuit having a resistor and a thyristor connected in series with the resistor; and a chopper controller coupled to the positive DC voltage terminal, the negative DC voltage terminal, and the thyristor, the chopper controller configured to activate the chopper circuit based on a differential DC voltage between the positive DC voltage terminal and the negative DC voltage terminal exceeding a junction threshold voltage.

In another aspect of the present disclosure, an energy transfer system is provided. The energy transfer system includes a plurality of inverters including a positive DC voltage terminal and a negative DC voltage terminal; a transformer configured to receive AC power from an external AC source including a primary winding configured to couple to the external AC source and a secondary winding coupled to the plurality of inverters; a transient overvoltage protection circuit including a first surge arrester coupled between the positive DC voltage terminal and an electrical ground of the energy transfer system, a second surge arrester coupled between the negative DC voltage terminal and the electrical ground, a chopper circuit coupled between the positive DC voltage terminal and the negative DC voltage terminal having a resistor and a thyristor connected in series with the resistor; and a chopper controller coupled to the positive DC voltage terminal, the negative DC voltage terminal, and the thyristor, wherein the chopper controller is configured to activate the chopper circuit based on a differential DC voltage between the positive DC voltage terminal and the negative DC voltage terminal exceeding a junction threshold voltage.

In yet another aspect of the present disclosure, a method for operating the transient overvoltage protection circuit is provided. The method includes connecting a first surge arrester between a positive DC voltage terminal of an energy transfer system and an electrical ground of the energy transfer system; connecting a second surge arrester between a negative DC voltage terminal of the energy transfer system and the electrical ground; connecting a chopper circuit including a resistor and a thyristor connected in series with the resistor between the positive DC voltage terminal and the negative DC voltage terminal, connecting a chopper controller to the positive DC voltage terminal, the negative DC voltage terminal, and the thyristor; connecting the positive DC voltage terminal to a positive rail of power rails; connecting the negative DC voltage terminal to a negative rail of the power rails; and activating, by the chopper controller, the chopper circuit based on a differential DC voltage between the positive DC voltage terminal and the negative DC voltage terminal exceeding a junction threshold voltage, the differential DC voltage received from the power rails.

### BRIEF DESCRIPTION OF DRAWINGS

The detailed description references the accompanying figures. In the figures, the left-most digit of a reference number identifies the figure in which the reference number first appears. The same reference numbers indicate similar or identical items.

FIG. 1 is a schematic illustration of an electrically powered work machine coupled to a roadside power source.

FIG. 2 provides front and side views of an energy transfer system and power rails connected to the energy transfer system for transferring electrical energy to the electrically powered work machine via contactors.

FIG. 3 is a schematic diagram of a transient overvoltage protection circuit coupled to power rails for powering the electrically powered work machine by way of contactors.

FIG. 4 illustrates example simulation graphs of a 5 kV surge on the power rails with a duration of 100 μsec and 20 msec at 2 km and 200 m from the energy transfer system without the transient overvoltage protection circuit.

FIG. 5 illustrates example simulation graphs of a 5 kV surge on the power rails with a duration of 20 msec at 2 km, 1 km, 500 m, and 250 m from the energy transfer system utilizing the transient overvoltage protection circuit.

FIG. 6 is a flow chart illustrating a process for operating the transient overvoltage protection circuit.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

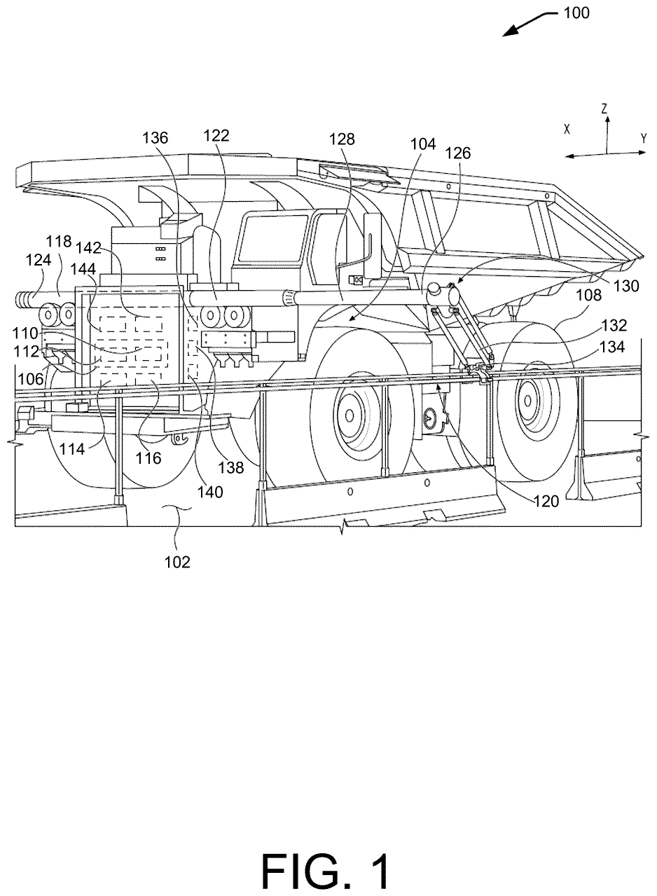

FIG. 1 illustrates an isometric view of an example work machine 100 within an XYZ coordinate system as one example suitable for receiving charging current and/or powering voltage from the configurable substation of this disclosure. The work machine 100 may be an electrically powered work machine. The work machine 100 travels parallel to the X axis along a roadway, also termed a haul route 102, typically from a source to a destination within a worksite. In one implementation as illustrated, the work machine 100 is a hauling machine that hauls a load within or from a worksite within a mining operation. For instance, the work machine 100 may haul excavated ore or other earthen materials from an excavation area along the haul route 102 to dump sites and then return to the excavation area. In this arrangement, the work machine 100 may be one of many similar machines configured to ferry earthen material in a trolley arrangement. While a large mining truck in this instance, the work machine 100 may be any machine that carries a load between different locations within a worksite, examples of which include an articulated truck, an off-highway truck, an on-highway dump truck, a wheel tractor scraper, or any other similar machine. Alternatively, the work machine 100 may be an off-highway truck, on-highway truck, a dump truck, an articulated truck, a loader, an excavator, a pipe layer, or a motor grader. In other implementations, the work machine 100 need not haul a load and may be any machine associated with various industrial applications including, but not limited to, mining, agriculture, forestry, construction, and other industrial applications.

Referring to FIG. 1, and relevant to the present disclosure, the work machine 100 includes a frame 104 powered by an electric engine 106 to cause rotation of traction devices 108. The traction devices 108 are typically four or more wheels with tires, although tracks or other mechanisms for engagement with the ground along the haul route 102 are possible. The electric engine 106 provides mechanical energy to the work machine 100 based on electrical power sources, such as described in further detail below. An example of mechanical energy provided by the electric engine 106 includes propelling the traction devices 108 to cause movement of the work machine 100 along the haul route 102, but the electric engine 106 also includes components sufficient to power other affiliated operations within the work machine 100. For instance, in some implementations, the electric engine 106 includes equipment for converting electrical energy to provide pneumatic or hydraulic actions within the work machine 100. While the electric engine 106 is configured to operate from an external electrical power source, the electric engine 106 typically includes one or more batteries for storing electrical energy for auxiliary or backup operations, as discussed in more detail below.

The electric engine 106 includes one or more motors 110 responsible for generating torque to propel the work machine 100. The motors 110 may be of any suitable type, such as induction motors, permanent magnet motors, switched reluctance (SR) motors, combinations thereof, or the like. The motors 110 are of any suitable voltage, current, and/or power rating. The motors 110 when operating together are configured to propel the work machine 100 as needed for tasks that are to be performed by the work machine 100. For example, the motors 110 may be rated for a range of about 500V to about 3000V. A motor controller 112 includes control electronics configured to control the operation of the motors 110. In some cases, each motor 110 may be controlled by its own motor controller 112. In other cases, all the motors of the work machine 100 may be controlled by a single motor controller 112. The motor controller 112 may further include one or more inverters or other circuitry to control the energizing of magnetic flux generating elements (e.g., coils) of the motors 110. These inverters may include IGBT-based components, which may experience an insulation failure if a voltage across insulation (insulation voltage, V_{INS}) of the IGBT exceeds an insulation threshold voltage and experience a junction breakdown if a collector-to-emitter voltage, V_{CE}, exceeds a junction threshold voltage. The motors 110 are mechanically coupled to a variety of drive train components, such as a drive shaft and/or axles or directly to the traction devices 108 to propel the work machine 100. Although not shown here, there may be one or more motors that are not used for propulsion of the work machine 100, but rather to operate pumps and/or other auxiliary components, such as to operate hydraulic systems.

According to examples of the disclosure, electrical power to energize the motors 110 is received from a battery module 114. The battery module 114 may provide power for operating the motors 110 and/or other power consuming components (e.g., controllers, cooling systems, displays, actuators, sensors, etc.) of the work machine 100. The presently disclosed subject matter is not limited solely to the use of battery power, as other forms of energy may be used in conjunction with the power provided by the battery module 114, including, but not limited to, internal combustion engines or fuel cells, and external electrical sources discussed further below.

The battery module 114 may be of any suitable type and capacity. The battery module 114 includes one or more cells, that when electrically connected, operate as a battery to provide the voltage, current, and/or power requirements of the work machine 100. For example, the battery module 114 may include cells forming a lithium ion battery, a lead-acid battery, an aluminum ion battery, a flow battery, a magnesium ion battery, a potassium ion battery, a sodium ion battery, a metal hydride battery, a nickel metal hydride battery, a cobalt metal hydride battery, a nickel-cadmium battery, a wet cell of any type, a dry cell of any type, a gel battery, combinations thereof, or the like. A battery controller 116 monitors and controls various aspects of the battery module 114, such as controlling a temperature of the battery, the prevention of an over discharge condition, and charging characteristics and demands.

In addition to, or alternative to, obtaining electrical energy from the battery module 114, the electric engine 106 may obtain electrical energy from an external source. For example, the work machine 100 further includes a conductor rod 118 configured to receive electrical power from power rails 120 connected to an energy transfer system (not shown). In some examples, the power rails 120 are one or more beams of metal arranged substantially parallel to and a distance above the ground. In FIG. 1, the power rails 120 are positioned to be substantially parallel to the X axis and the direction of travel of the work machine 100. Support mechanisms hold the power rails 120 in place along a distance at the side of the haul route 102 for the work machine 100 to traverse. While shown in FIG. 1 to the left of the work machine 100 as the work machine 100 travels in the direction of the X axis, the power rails 120 may be installed to the right of the work machine 100 or in other locations suitable to the implementation.

The power rails 120 provide a source of electrical power for the work machine 100 as either AC or DC. In some examples, the power rails 120 have two or more conductors, each providing voltage and current at a different electrical pole. In one implementation (e.g., an implementation in which the power rails 120 include three conductors), one conductor provides positive DC voltage, a second conductor provides negative DC voltage, and a third conductor provides an electrical or earth ground, i.e., 0V relative to the other two conductors. The two powered conductors within the power rails 120 can provide a variety of voltage levels, such as a voltage difference greater than 2500V, which may be delivered as +1500VDC and −1500VDC in one example to provide 3000VDC. These values are exemplary, and other physical and electrical configurations for the power rails 120 are available and within the knowledge of those of ordinary skill in the art.

The conductor rod 118 enables electrical connection between the work machine 100 and the power rails 120, including during movement of the work machine 100 along the haul route 102. In the example shown in FIG. 1, the conductor rod 118 is an elongated arm resembling a pole. FIG. 1 shows the conductor rod 118 positioned along a front side of the work machine 100, with respect to the direction of travel of the work machine 100 in the direction of the X axis. As embodied in FIG. 1, the conductor rod 118 includes a barrel 122 mounted to the frame 104 of the work machine 100. The barrel 122 has a hollow interior and may be a conductive metal having suitable mechanical strength and resiliency, such as aluminum. Within, and possibly including the barrel 122, the conductor rod 118 includes a series of electrical conductors passing longitudinally, at least from a head 124 at a proximal end to a tip 126 at a distal end. Tubular conductors within an arm 128 slidably engage with corresponding tubular conductors within the barrel 122 to maintain electrical continuity as the arm 128 is extended or retracted. In other examples, the conductor rod 118 may comprise a boom with a trailing or a folding arm that is selectively movable with respect to the frame 104 between a retracted position and an extended position. The boom may be pivotably connected to the frame 104, while the trailing arm may be capable of being contracted or folded in a storage configuration when not in use.

At a position away from the work machine 100 at the tip 126, a connector assembly 130 provides an interface to the power rails 120 via trailing arms 132 and contactors 134. The power rails 120 are typically arranged along a side of the haul route 102, and the work machine 100 is steered so that it traverses the haul route 102 substantially in parallel with the power rails 120. The contactors 134 may include multiple degrees of freedom to allow the contactors 134 to align and ride on top of the power rails 120. In operation, electrical power is accessed from the power rails 120 via the contactors 134, and the electrical power is conducted through the trailing arms 132 into the connector assembly 130 and to the work machine 100 for powering the electric engine 106 and otherwise enabling operations within the work machine 100.

The different voltages provided by the battery module 114 and the power rails 120, along with other voltages used within the work machine 100, may be distributed within the work machine 100 on two or more voltage buses. In one example, the work machine 100 has two voltage buses, a battery bus 136 and an accessory bus 138. In this situation, a traction system (not shown) within the work machine 100 for propelling the traction devices 108 may be configured to operate from a voltage level V1 provided by the battery module 114. This battery voltage V1 may be greater than 700 volts, such as approximately from 750VDC to approximately 1500VDC, which would be provided on the battery bus 136 from the battery module 114 at least to the traction system within the work machine 100. Electrical accessories within the work machine 100, such as a water pump, an electric fan, a heating, ventilation, and air conditioning (HVAC) system, or a battery management system (BMS), typically require a lower voltage, so the battery voltage V1 is converted within the work machine 100 to a lower DC voltage V2, such as approximately from 550VDC to 700VDC, for distribution on the accessory bus 138. In this two-bus example, a high voltage V3 received from an external source, namely, the power rails 120 providing a voltage difference greater than 2500VDC, such as approximately from 2600VDC to 3000VDC, would be stepped down to match the battery voltage V1 and then joined into the battery bus 136.

In another example, the work machine 100 has three voltage buses—the battery bus 136, the accessory bus 138, and a traction bus 140. In this situation, the traction system may be configured to operate from voltage level V3 provided by the power rails 120, i.e., at about 2600VDC to 3000VDC. As a result, battery voltage V1 on the battery bus 136 is stepped up to match voltage level V3, i.e., traction voltage V3 on the traction bus 140. Thus, in this example, the traction bus 140 carries about 2600VDC to 3000VDC, while the battery bus 136 carries battery voltage V1 of about 1100VDC to 1500VDC, and the accessory bus 138 carries a lesser voltage V2 of about 550 700VDC. The voltages for each of these buses are exemplary only and other voltage values and ranges may be adopted without departing from the principles of this disclosure.

In some examples, the work machine 100 includes one or more interfaces, such as a first charge port 142 and a second charge port 144, for receiving electrical energy from an external source to charge the battery module 114. As discussed in further detail below, the external source may be a fast-charging circuit that can charge the battery module 114 in 20 to 30 minutes, for example, when the work machine 100 is stationary. The first charge port 142 and the second charge port 144 are coupled to the battery bus 136 to provide, separately or together, sufficient charging current from the external source at battery voltage V1 while the work machine 100 is out of service. While the contactors 134 may conduct electrical power to the work machine 100 from the power rails 120, making and breaking contact with the power rails 120 may cause transient overvoltage, which may damage circuits in the energy transfer system without a transient overvoltage protection circuit

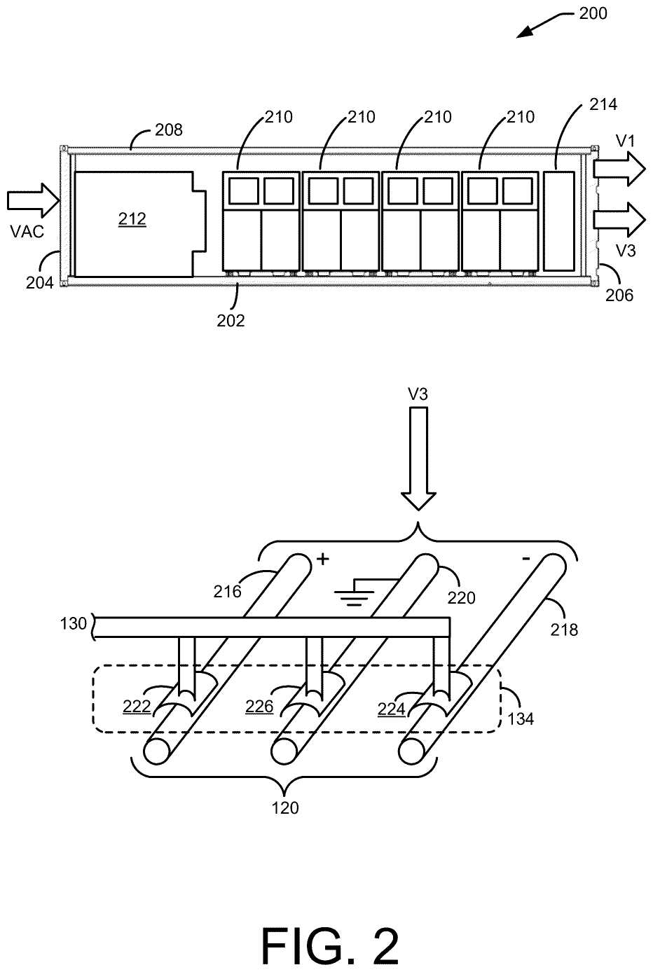

FIG. 2 provides an isometric view of an example energy transfer system 200 and the power rails 120 connected to the energy transfer system 200 for transferring electrical energy to the work machine 100 via the contactors 134 suitable for carrying out the principles discussed in the present disclosure. In one configuration, the energy transfer system 200 provides DC electrical energy for powering the electric engine 106 to cause movement of the work machine 100, such as by providing voltage V3 to the work machine 100 via the power rails 120. In another configuration, the energy transfer system 200 provides DC electrical energy for charging the battery module 114 while the work machine 100 is stationary, such as by providing voltage V1 to the work machine 100 via one or more of charge ports, such as the first charge port 142 and the second charge port 144.

As illustrated in FIG. 2, the energy transfer system 200 in some examples includes an external structure with walls and a roof to protect its equipment from the environment and to protect personnel from hazardous voltages. The energy transfer system 200 receives AC voltage from an external source (not shown), such as AC distribution power denoted VAC as an input in FIG. 2, and transforms and conditions that AC voltage into different levels of DC voltage, such as outputs V1 and V3 in FIG. 2. The converted DC voltages are then provided for use by a load (not shown), such as the work machine 100. While not shown, the energy transfer system 200 may house a transformer configured to couple to an external AC source, a plurality of modular cabinets coupled to the transformer, each modular cabinet comprising one or more sets of inverters for converting AC voltage from the transformer to DC voltage, an interface box for controlling the DC voltage from the plurality of cabinets to produce desired output DC voltage, such as V1 for charging the battery module 114 via the first charge port 142 and the second charge port 144 and V3 for powering the work machine 100 via the power rails 120.

The energy transfer system 200 may be located in any environment requiring DC distribution voltage, particularly situations in which the substation may be periodically commissioned, decommissioned, and relocated. The energy transfer system 200 is essentially self-contained and suited for environments where electrical equipment and related resources may otherwise be lacking. In some examples, the environment for the energy transfer system 200 is a mine site or a logging site in a remote location, and the load is the work machine 100 powered by the DC voltage to haul a load. In other implementations, the heavy work machine need not haul a load and may be any machine associated with various industrial applications including, but not limited to, mining, agriculture, forestry, construction, and other industrial applications.

As illustrated in FIG. 2, the energy transfer system 200 is cuboid in shape, although other forms for the energy transfer system 200 are possible depending on the implementation. The exterior structure includes a base 202, a front wall (not shown), a rear wall on the opposite side of the front wall (not shown), a first end wall 204, a second end wall 206, and a roof 208. One or more doors within the walls of the energy transfer system 200 provide access to the interior of the structure. Due to heat generated by electrical equipment within the energy transfer system 200 described below, several air-conditioning units cool the interior and may form part of one or more walls. In some examples, the energy transfer system 200 is elevated from ground by support structures, such as piers (not shown). The piers may be of any shape or composition and serve to hold the energy transfer system 200 above the ground. In some examples, the piers are about 1.0 meter in height.

In some examples, the energy transfer system 200 is a modular and portable structure. To facilitate shipment, the energy transfer system 200 is intended to have an external size sufficient when assembled to fit within, i.e., to conform to the internal dimensions of, a shipping container of standard size. In one example, a Series 1AAA standard “high cube” intermodal shipping container according to International Organization for Standardization (ISO) standard 668:2020, has a length of 40 feet (12.19 meters), a width of eight feet (2.44 meters), and a height of 9.6 feet (2.5 meters). As a result, the energy transfer system 200 may be loaded in one example into a shipping container conforming to ISO 668:2020, shipped to a location within a work site, unloaded, and configured for operation with minimal additional parts or setup activities. Similarly, the energy transfer system 200 may be decommissioned from the location and readily moved intact to a new destination, such as another location within the site as work evolves. Shipping containers of other sizes and standards are also possible for transporting the energy transfer system 200 based on the size and electrical performance of the equipment and the logistics of moving the energy transfer system 200 between locations.

The energy transfer system 200 may include a plurality of modular cabinets 210, each including a plurality of inverters (not shown), receiving AC power from a transformer 212. The energy transfer system 200 may generate V1 and V3 from outputs of the plurality of modular cabinets 210 through a transient overvoltage protection circuit 214, and supply one or more of V1 and V3 through electrical conductors coupled to the work machine 100. The transformer 212 may be a three-winding transformer having a primary winding for coupling to an external AC source, a secondary winding for coupling to a first plurality of inverters, and a tertiary winding for coupling to a second plurality of inverters. In some examples, the transformer 212 of the energy transfer system 200 receives an AC voltage input VAC generally in the range of 11 kV to 33 kV three-phase AC electricity at 50 Hz or 60 Hz from an external source such as an AC medium-voltage distribution line. In one mode, in which the energy transfer system 200 functions as an Energy Transfer Unit (ETU), the energy transfer system 200 may transform and convert the AC voltage input to a DC voltage output V1 of up to 1500VDC at about 4800 A of current at about 6 MW of power, which may be used to charge batteries of a stationary vehicle. In this situation, the energy transfer system 200 may operate as a current source and provide stable electrical current at voltage V1 to one or both of the first charge port 142 and the second charge port 144 through cables or similar conductors while the work machine 100 is out of service. In another mode, the energy transfer system 200 may provide Dynamic Energy Transfer (DET) to a vehicle in motion, transforming the AC voltage input to a DC voltage output V3 of up to 3000VDC at about 3600 A of current and about 6 MW of power. In this situation, the energy transfer system 200 can operate as a voltage source and provide stable electrical voltage at V3 (or in some implementations, at V1) to the power rails 120, which may be accessed by the contactors 134 on the work machine 100. It should be noted that the AC voltage input ranges and/or the DC voltage output ranges are examples, and the present disclosure contemplates other suitable values of the AC voltage input and/or the DC voltage output. In this example, the power rails 120 is shown to include a positive rail 216, a negative rail 218, and a ground rail 220, and the contactors 134 is shown to include a positive contact 222, a negative contact 224, and a ground contact 226. The contactors 134 may make contact with the power rails 120, and the work machine 100 may receive electrical power from the power rails 120.

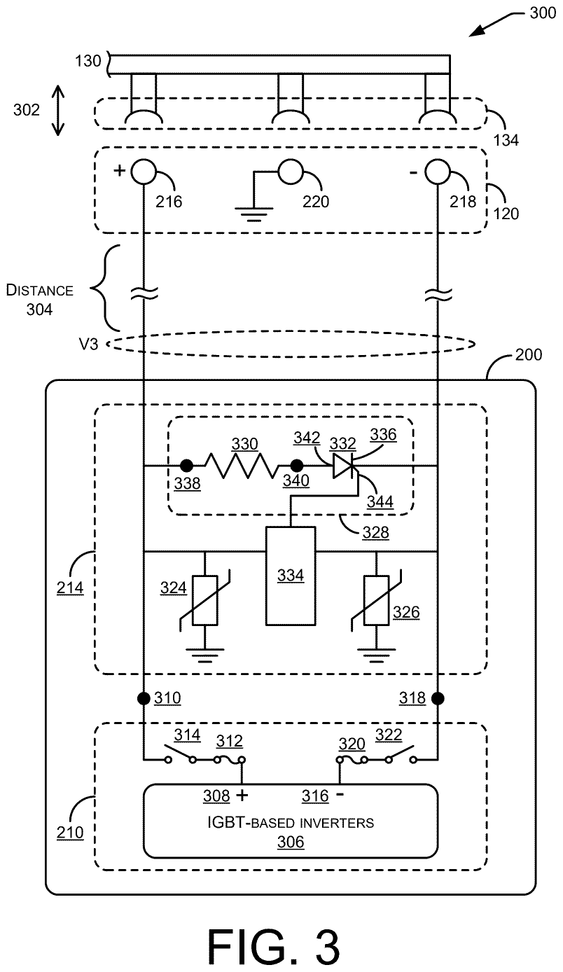

FIG. 3 is a schematic diagram 300 of a transient overvoltage protection circuit 214 coupled to the power rails 120 for powering the work machine 100 by way of the contactors 134. As described above with reference to FIGS. 1 and 2, the work machine 100 may raise or lower the contactors 134 to make or break contact with the power rails 120 as shown by arrow 302. The work machine 100 may be located at a distance 304, such as 200 m, 500 m, 2 km, etc., away from the energy transfer system 200, and the contactors 134 may make or break contact with the power rails 120 spanning the distance 304 between the energy transfer system 200 and the work machine 100. As the contactors 134 make or break contact with the power rails 120 at the distance 304 from the energy transfer system 200 while the power rails 120 are powered, a surge, or a transient overvoltage pulse, may be generated. The transient overvoltage pulse may travel on the power rails 120 and arrive at energy transfer system 200. The transient overvoltage pulse may be short in duration but may be high enough in voltage to damage IGBT-based components of inverters in the plurality of modular cabinets 210. The transient overvoltage protection circuit 214 may be utilized to suppress the transient overvoltage to protect the IGBT-based components.

As described above with reference to FIG. 2, the energy transfer system 200 may comprise the plurality of modular cabinets 210 (one cabinet shown) housing a plurality of inverters, which may be a plurality of IGBT-based inverters 306 of the same type. A positive output 308 of the plurality of IGBT-based inverters 306 may be coupled to a positive DC voltage terminal 310 of the energy transfer system 200 through a fuse 312 and a switch 314, and a negative output 316 of the plurality of IGBT-based inverters 306 may be coupled to a negative DC voltage terminal 318 of the energy transfer system 200 through a fuse 320 and a switch 322. The positive DC voltage terminal 310 may be coupled to the positive rail 216 and the negative DC voltage terminal 318 may be coupled to the negative rail 218, to power to the power rails 120.

The transient overvoltage protection circuit 214 may comprise a first surge arrester 324, a second surge arrester 326, a chopper circuit 328 including a resistor 330 and a thyristor 332 connected in series, and a chopper controller 334. The first surge arrester 324 may be coupled between the positive DC voltage terminal 310 and an electrical ground of the energy transfer system 200, and the second surge arrester 326 may be coupled between the negative DC voltage terminal 318 and the electrical ground of the energy transfer system 200. The first surge arrester 324 may have, or may be characterized, by a first continuous operating voltage and a first peak voltage. The first continuous operating voltage of the first surge arrester 324 may be selected based on an operational voltage of the energy transfer system 200, such as, but not limited to 750VDC-1500VDC. The first peak voltage of the first surge arrester 324, which is a maximum voltage the first surge arrester 324 is capable of tolerating for a first time interval, may be selected based on an insulation threshold voltage of an IGBT, for example, IGBTs in the plurality of IGBT-based inverters 306, above which the IGBTs may be damaged. The second surge arrester 326 may have, or may be characterized, by a second continuous operating voltage and a second peak voltage. The second continuous operating voltage of the second surge arrester 326 may also be selected based on the operational voltage of the energy transfer system 200, such as, but not limited to 750VDC-1500VDC. The second peak voltage of the second surge arrester 326 may also be selected based on the insulation threshold voltage of an IGBT, for example, IGBTs in the plurality of IGBT-based inverters 306. The first surge arrester 324 and the second surge arrester 326 may be of the same type having the same characteristics.

The chopper circuit 328 may be coupled between the positive DC voltage terminal 310 and the negative DC voltage terminal 318, where an anode 336 of the thyristor 332 may be connected to the negative DC voltage terminal 318 either directly or through the resistor 330. In this example in FIG. 3, the chopper circuit 328 is shown as a first terminal 338 of the resistor 330 directly connected to the positive DC voltage terminal 310, a second terminal 340 of the resistor 330 connected to a cathode 342 of the thyristor 332, and the anode 336 of the thyristor 332 connected directly to the negative DC voltage terminal 318. To control the chopper circuit, the chopper controller 334 may compare a differential DC voltage between the positive DC voltage terminal 310 and the negative DC voltage terminal 318 to a junction threshold voltage, and activate chopper circuit 328, or more specifically, the thyristor 332, based on the differential DC voltage exceeding the junction threshold voltage. The junction threshold voltage may be set based on a breakdown voltage of a PN junction of an IGBT, for example, but not limited to, 1.05 kV while the normal operating voltage may be 750 V. For a configuration of four IGBT-based inverters in series, the normal operating voltage may be 3 kV (=4×750 V) while the breakdown voltage may be 4.2 kV (=4×1.05 kV). The junction threshold voltage may then be lower than the breakdown voltage of 4.2 kV to prevent the PN junction from reaching the breakdown voltage. The chopper controller 334 may be an analog comparator configured to compare the differential DC voltage to the junction threshold voltage, and activate the chopper circuit 328 by, for example, controlling a gate 344 of the thyristor 332, based on the differential DC voltage exceeding the junction threshold voltage.

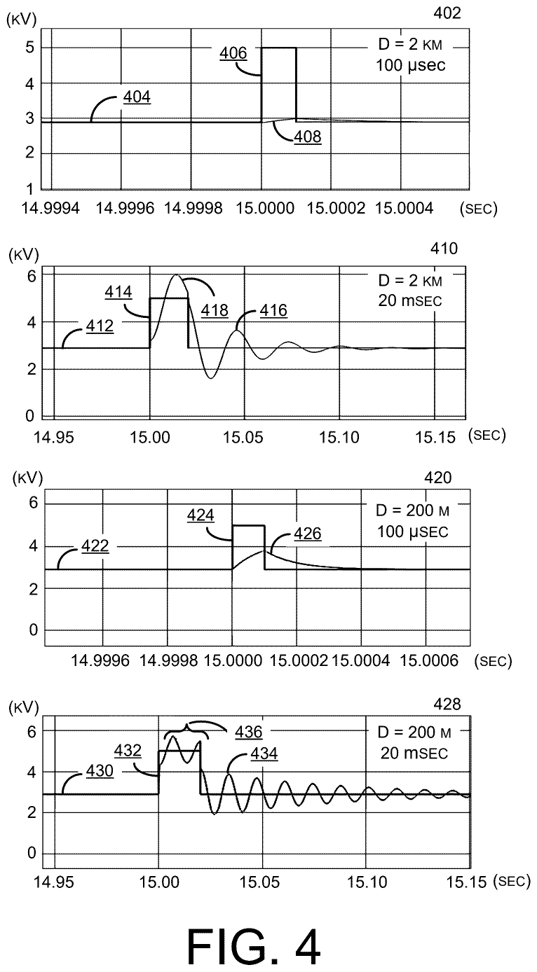

FIG. 4 illustrates example simulation graphs of a 5 kV surge on the power rails 120 with a duration of 100 μsec and 20 msec at 2 km and 200 m from the energy transfer system 200 providing 3 kV on the power rails 120. Resulting transient pulses arriving at the positive DC voltage terminal 310 and the negative DC voltage terminal 318 of the energy transfer system 200 without the transient overvoltage protection circuit 214 are also shown over the 5 kV surge. The 5 kV surge may represent a surge generated by the contactors 134 making or breaking contact with the power rails 120, as discussed above with reference to FIG. 3, and may be based on historical data.

Graph 402 illustrates a voltage trace 404 of the power rails 120 at the distance 304 of 2 km with a first surge 406 of 5 kV with a first duration of 100 μsec. A first resulting transient pulse trace 408 indicates a small increase in voltage, which does not exceed the breakdown voltage of 4.2 kV, observed at the positive DC voltage terminal 310 and the negative DC voltage terminal 318 of the energy transfer system 200. Graph 410 illustrates a voltage trace 412 of the power rails 120 at the distance 304 of 2 km with a second surge 414 of 5 kV with a second duration of 20 msec. A second resulting transient pulse trace 416 indicates an initial peak 418 of 6 kV, exceeding the breakdown voltage of 4.2 kV, observed at the positive DC voltage terminal 310 and the negative DC voltage terminal 318 of the energy transfer system 200.

Graph 420 illustrates a voltage trace 422 of the power rails 120 at the distance 304 of 200 m with a third surge 424 of 5 kV with a third duration of 100 μsec. A third resulting transient pulse trace 426 indicates a larger increase in voltage than the first resulting transient pulse trace 408, which does not exceed the breakdown voltage of 4.2 kV, observed at the positive DC voltage terminal 310 and the negative DC voltage terminal 318 of the energy transfer system 200. Graph 428 illustrates a voltage trace 430 of the power rails 120 at the distance 304 of 200 m with a fourth surge 432 of 5 kV with a fourth duration of 20 msec. A fourth resulting transient pulse trace 434 indicates large initial pulses 436, exceeding the breakdown voltage of 4.2 kV, observed at the positive DC voltage terminal 310 and the negative DC voltage terminal 318 of the energy transfer system 200.

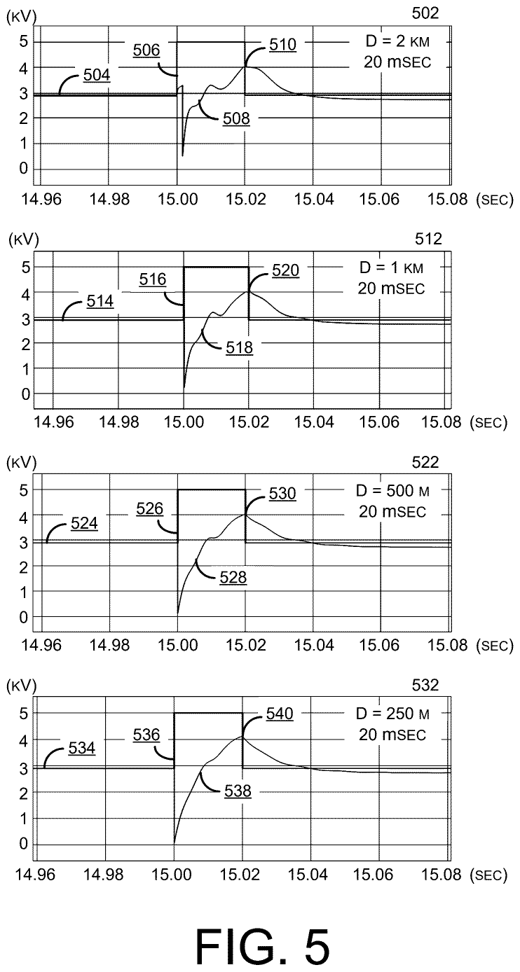

FIG. 5 illustrates example simulation graphs of a 5 kV surge on the power rails 120 with a duration 20 msec at 2 km, 1 km, 500 m, and 250 m from the energy transfer system 200 providing 3 kV on the power rails 120. Resulting transient pulses arriving at the positive DC voltage terminal 310 and the negative DC voltage terminal 318 of the energy transfer system 200 utilizing the transient overvoltage protection circuit 214 are also shown over the 5 kV surge. The 5 kV surge may represent a surge generated by the contactors 134 making or breaking contact with the power rails 120, as discussed above with reference to FIG. 3, and may be based on historical data.

Graph 502 illustrates a voltage trace 504 of the power rails 120 at the distance 304 of 2 km with a fifth surge 506 of 5 kV with a fifth duration of 20 msec. A fifth resulting transient pulse trace 508 indicates a peak voltage 510 of 4 kV, which is below the breakdown voltage of 4.2 kV, observed at the positive DC voltage terminal 310 and the negative DC voltage terminal 318 of the energy transfer system 200. Compared to the voltage of the initial peak 418 of 6 kV without the transient overvoltage protection circuit 214 as illustrated in the graph 410 of FIG. 4, the peak voltage 510 observed at the positive DC voltage terminal 310 and the negative DC voltage terminal 318 of the energy transfer system 200 is reduced to a voltage below the breakdown voltage with the transient overvoltage protection circuit 214.

Graph 512 illustrates a voltage trace 514 of the power rails 120 at the distance 304 of 1 km with a sixth surge 516 of 5 kV with a sixth duration of 20 msec. A sixth resulting transient pulse trace 518 indicates a peak voltage 520 of 4 kV, which is also below the breakdown voltage of 4.2 kV, observed at the positive DC voltage terminal 310 and the negative DC voltage terminal 318 of the energy transfer system 200 with the transient overvoltage protection circuit 214. Graph 522 illustrates a voltage trace 524 of the power rails 120 at the distance 304 of 500 m with a seventh surge 526 of 5 kV with a seventh duration of 20 msec. A seventh resulting transient pulse trace 528 indicates a peak voltage 530 of 4 kV, which is also below the breakdown voltage of 4.2 kV, observed at the positive DC voltage terminal 310 and the negative DC voltage terminal 318 of the energy transfer system 200 with the transient overvoltage protection circuit 214. Graph 532 illustrates a voltage trace 534 of the power rails 120 at the distance 304 of 250 m with an eighth surge 536 of 5 kV with an eighth duration of 20 msec. An eighth resulting transient pulse trace 538 indicates a peak voltage 540 of above 4 kV but below the breakdown voltage of 4.2 kV observed at the positive DC voltage terminal 310 and the negative DC voltage terminal 318 of the energy transfer system 200 with the transient overvoltage protection circuit 214. As shown in the graphs 502, 512, 522, and 532, the transient overvoltage protection circuit 214 provides protection to IGBTs, such as the IGBTs in the plurality of IGBT-based inverters 306, against a transient overvoltage pulse, or a surge, on the power rails 120, by dampening or reducing a peak voltage of the surge.

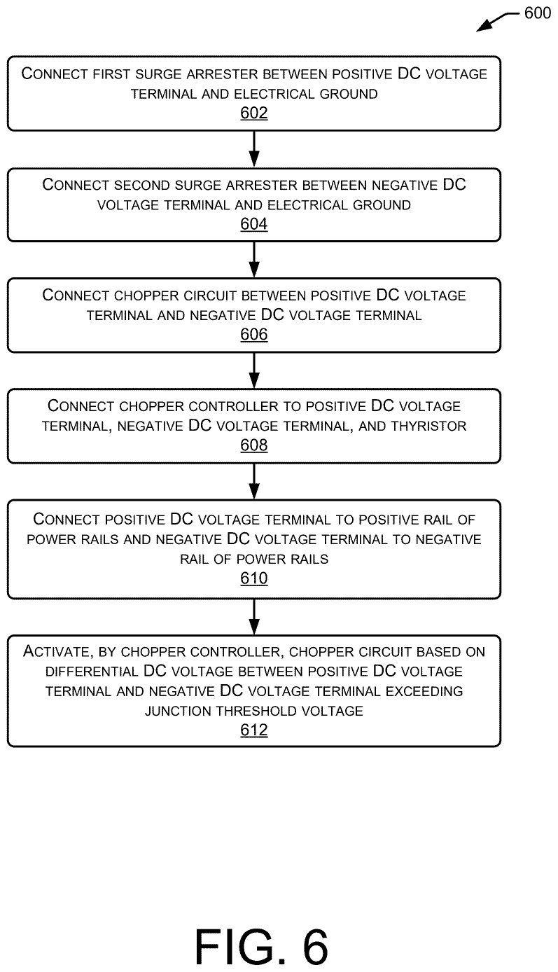

FIG. 6 is a flow chart illustrating an example process 600 for operating the transient overvoltage protection circuit 214 as described above with reference to FIG. 3. The example process 600 is illustrated as a collection of steps in a logical flow diagram, which represents operations that can be performed in configuring the transient overvoltage protection circuit 214 coupled to the energy transfer system 200 and the power rails 120 as described above with reference to FIG. 3. The order in which the operations are described is not intended to be construed as a limitation, and any number of the described steps can be combined and performed in any order, in parallel, or simultaneously to implement the process.

At block 602, a first surge arrester, such as the first surge arrester 324, may be connected between a positive DC voltage terminal, such as the positive DC voltage terminal 310 of an energy transfer system, such as the energy transfer system 200, and an electrical ground of the energy transfer system 200. At block 604, a second surge arrester, such as the second surge arrester 326, may be connected between a negative DC voltage terminal, such as the negative DC voltage terminal 318 of the energy transfer system 200, and the electrical ground. The first surge arrester 324 and the second surge arrester 326 are designed to protect IGBTs, such as the IGBTs of the IGBT-based circuits in the plurality of IGBT-based inverters 306, by limiting voltage from the surge by discharging or bypassing surge current to the ground. At block 606, a chopper circuit, such as the chopper circuit 328, may be connected between the positive DC voltage terminal 310 and the negative DC voltage terminal 318. As described above with reference to FIG. 3, the chopper circuit 328 may include a resistor, such as the resistor 330, and a thyristor, such as the thyristor 332, connected in series with the resistor 330, where an anode 336 of the thyristor 332 may be connected directly to the positive DC voltage terminal 310 or be connected to the positive DC voltage terminal 310 through the resistor 330. At block 608, a chopper controller, such as the chopper controller 334, may be connected to the positive DC voltage terminal 310, the negative DC voltage terminal 318, and the thyristor 332. At block 610, the positive DC voltage terminal 310 may be connected to a positive rail of power rails, such as the positive rail 216 of the power rails 120, and the negative DC voltage terminal 318 may be connected to a negative rail, such as such as the negative rail 218 of the power rails 120. At block 612, the chopper controller 334 may activate the chopper circuit 328 based on a differential DC voltage between the positive DC voltage terminal 310 and the negative DC voltage terminal 318 exceeding a junction threshold voltage, where the differential DC voltage is received from the power rails 120. For example, as described above with reference to FIGS. 3-5, the contactors 134 making or breaking contact with the power rails 120 may generate a surge and cause the differential DC voltage between the positive DC voltage terminal 310 and the negative DC voltage terminal 318.

The first surge arrester 324 may include a first continuous operating voltage and a first peak voltage, where the first peak voltage is a maximum voltage that the first surge arrester 324 is capable of tolerating for a first time interval, and the second surge arrester 326 may include a second continuous operating voltage and a second peak voltage, where the second peak voltage is a maximum voltage the second surge arrester 326 is capable of tolerating for a second time interval. The first continuous operating voltage and the second continuous operating voltage may be determined based on an operational voltage of the energy transfer system 200. The energy transfer system 200 may include, such as the plurality of IGBT-based inverters 306. The plurality of inverters may be of a same type having insulated gate bipolar transistor (IGBT)-based circuits having a plurality of IGBTs. The first peak voltage and the second peak voltage may be determined based on an insulation threshold voltage of an IGBT, where the insulation threshold voltage is a voltage above which the IGBT may be damaged. The junction threshold voltage may be set based on a breakdown voltage of a PN junction of an IGBT and is lower than the breakdown voltage to prevent damage to the IGBT.

Those of ordinary skill in the field will appreciate that the principles of this disclosure are not limited to the specific examples discussed or illustrated in the figures. For example, while the energy transfer system has been discussed in the context of fitting within a standard size container for portability, the described concepts are applicable beyond the constraints of that housing. Moreover, while the megawatt power inverters are described for supplying voltage and/or current to a heavy work machine, other types of vehicles or equipment may benefit from the principles described and illustrated. As well, it will be understood that the power inverters of the disclosed energy transfer station may be coupled to one or more additional energy transfer station to attain different output capacities as a group.

### Industrial Applicability

The present disclosure provides systems and methods of a transient overvoltage protection circuit for preventing damages to insulated gate bipolar transistor (IGBT)-based circuits of a plurality of inverters in an energy transfer system providing electrical power to an electrically powered work machine. When contactors of the work machine make or break contact with power rails that provide electrical power to the work machine, a transient overvoltage, or a surge, may be generated on the power rail, which may damage the IGBT-based circuits of the plurality of inverters. The transient overvoltage protection circuit includes a first surge arrester coupled between a positive DC voltage terminal of an energy transfer system and an electrical ground of the energy transfer system, the first surge arrester having a first continuous operating voltage and a first peak voltage, the first peak voltage being a maximum voltage the first surge arrester is capable of tolerating for a first time interval; a second surge arrester coupled between a negative DC voltage terminal of the energy transfer system and the electrical ground, the second surge arrester having a second continuous operating voltage and a second peak voltage, the second peak voltage being a maximum voltage the second surge arrester is capable of tolerating for a second time interval; a chopper circuit coupled between the positive DC voltage terminal and the negative DC voltage terminal, the chopper circuit having a resistor and a thyristor connected in series with the resistor; and a chopper controller coupled to the positive DC voltage terminal, the negative DC voltage terminal, and the thyristor, the chopper controller configured to activate the chopper circuit based on a differential DC voltage between the positive DC voltage terminal and the negative DC voltage terminal exceeding a junction threshold voltage.

The first peak voltage and the second peak voltage may be determined based on an insulation threshold voltage of an IGBT, where the insulation threshold voltage is a voltage above which the IGBT may be damaged. The junction threshold voltage may be set based on a breakdown voltage of a PN junction of an IGBT and is selected to be lower than the breakdown voltage to prevent damage to the IGBT. The first and second surge arresters protect IGBTs of the IGBT-based circuits in the plurality of IGBT-based inverters by limiting voltage from the surge by discharging or bypassing surge current to the ground. The chopper circuit disperses energy from the surge through the resistor when the voltage of the surge exceeds a junction threshold voltage to prevent the voltage.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the examples above, it will be understood by those skilled in the art that various additional embodiments may be contemplated by the modification of the disclosed devices, systems, and methods without departing from the spirit and scope of what is disclosed. Such embodiments should be understood to fall within the scope of the present disclosure as determined based upon the claims and any equivalents thereof.

What is claimed is:

1. A transient overvoltage protection circuit comprising:
a first surge arrester coupled between a positive DC voltage terminal of an energy transfer system and an electrical ground of the energy transfer system, the first surge arrester having a first continuous operating voltage and a first peak voltage, the first peak voltage being a maximum voltage the first surge arrester is capable of tolerating for a first time interval;
a second surge arrester coupled between a negative DC voltage terminal of the energy transfer system and the electrical ground, the second surge arrester having a second continuous operating voltage and a second peak voltage, the second peak voltage being a maximum voltage the second surge arrester is capable of tolerating for a second time interval;
a chopper circuit coupled between the positive DC voltage terminal and the negative DC voltage terminal, the chopper circuit comprising:
a resistor, and
a thyristor connected in series with the resistor, wherein an anode of the thyristor is:
connected directly to the positive DC voltage terminal, or
connected to the positive DC voltage terminal through the resistor; and
a chopper controller coupled to the positive DC voltage terminal, the negative DC voltage terminal, and the thyristor, the chopper controller configured to activate the chopper circuit based on a differential DC voltage between the positive DC voltage terminal and the negative DC voltage terminal exceeding a junction threshold voltage.

2. The transient overvoltage protection circuit of claim 1, wherein:
the positive DC voltage terminal is configured to couple to a positive rail of power rails, and
the negative DC voltage terminal is configured to couple to a negative rail of the power rails,
wherein the power rails provide electrical power to an electrically powered work machine through contactors.

3. The transient overvoltage protection circuit of claim 2, wherein the energy transfer system comprises a plurality of inverters of a same type having insulated gate bipolar transistor (IGBT)-based circuits having a plurality of IGBTs.

4. The transient overvoltage protection circuit of claim 3, wherein the first continuous operating voltage and the second continuous operating voltage are determined based on an operational voltage of the energy transfer system.

5. The transient overvoltage protection circuit of claim 3, wherein the first peak voltage and the second peak voltage are determined based on an insulation threshold voltage of an IGBT, the insulation threshold voltage being a voltage above which causing damages to the IGBT.

6. The transient overvoltage protection circuit of claim 3, wherein the junction threshold voltage is set based on a breakdown voltage of a PN junction of an IGBT, and is lower than the breakdown voltage.

7. The transient overvoltage protection circuit of claim 6, wherein the chopper controller is an analog comparator configured to:
compare the differential DC voltage to the junction threshold voltage, and
activate the chopper circuit based on the differential DC voltage exceeding the junction threshold voltage.

8. An energy transfer system comprising:
a plurality of inverters including:
a positive DC voltage terminal, and
a negative DC voltage terminal;
a transformer configured to receive AC power from an external AC source, the transformer including:
a primary winding configured to couple to the external AC source, and
a secondary winding coupled to the plurality of inverters, and
a transient overvoltage protection circuit comprising:
a first surge arrester coupled between the positive DC voltage terminal and an electrical ground of the energy transfer system, the first surge arrester having a first continuous operating voltage and a first peak voltage, the first peak voltage being a maximum voltage the first surge arrester is capable of tolerating for a first time interval;
a second surge arrester coupled between the negative DC voltage terminal and the electrical ground, the second surge arrester having a second continuous operating voltage and a second peak voltage, the second peak voltage being a maximum voltage the second surge arrester is capable of tolerating for a second time interval;
a chopper circuit coupled between the positive DC voltage terminal and the negative DC voltage terminal, the chopper circuit comprising:
a resistor, and
a thyristor connected in series with the resistor, wherein an anode of the thyristor is:
connected directly to the positive DC voltage terminal, or
connected to the positive DC voltage terminal through the resistor; and
a chopper controller coupled to the positive DC voltage terminal, the negative DC voltage terminal, and the thyristor, the chopper controller configured to activate the chopper circuit based on a differential DC voltage between the positive DC voltage terminal and the negative DC voltage terminal exceeding a junction threshold voltage.

9. The energy transfer system of claim 8, wherein:
the positive DC voltage terminal is configured to couple to a positive rail of power rails, and
the negative DC voltage terminal is configured to couple to a negative rail of the power rails,
wherein the power rails provide electrical power to an electrically powered work machine through contactors.

10. The energy transfer system of claim 9, wherein inverters of the plurality of inverters are of a same type having insulated gate bipolar transistor (IGBT)-based circuits having a plurality of IGBTs.

11. The energy transfer system of claim 10, wherein the first continuous operating voltage and the second continuous operating voltage are determined based on an operational voltage of the energy transfer system.

12. The energy transfer system of claim 10, wherein the first peak voltage and the second peak voltage are determined based on an insulation threshold voltage of an IGBT, the insulation threshold voltage being a voltage above which causing damages to the IGBT.

13. The energy transfer system of claim 10, wherein the junction threshold voltage is set based on a breakdown voltage of a PN junction of an IGBT and is lower than the breakdown voltage.

14. The energy transfer system of claim 13, wherein the chopper controller is an analog comparator configured to:
compare the differential DC voltage to the junction threshold voltage, and
activate the chopper circuit based on the differential DC voltage exceeding the junction threshold voltage.

15. The energy transfer system of claim 8, wherein the plurality of inverters is a first plurality of inverters,
the energy transfer system further comprising:
a second plurality of inverters coupled to the positive DC voltage terminal and the negative DC voltage terminal, the second plurality of inverters including a same number of inverters as the first plurality of inverters, and inverters of the second plurality of inverters are of a same type as the inverters of the first plurality of inverters,
wherein the transformer is a three-winding transformer further including a tertiary winding coupled to the second plurality of inverters.

16. A method, comprising:
connecting a first surge arrester between a positive DC voltage terminal of an energy transfer system and an electrical ground of the energy transfer system;
connecting a second surge arrester between a negative DC voltage terminal of the energy transfer system and the electrical ground;
connecting a chopper circuit between the positive DC voltage terminal and the negative DC voltage terminal, the chopper circuit comprising:
a resistor, and
a thyristor connected in series with the resistor, wherein an anode of the thyristor is:
connected directly to the positive DC voltage terminal, or
connected to the positive DC voltage terminal through the resistor;
connecting a chopper controller to the positive DC voltage terminal, the negative DC voltage terminal, and the thyristor;
connecting the positive DC voltage terminal to a positive rail of power rails;
connecting the negative DC voltage terminal to a negative rail of the power rails; and
activating, by the chopper controller, the chopper circuit based on a differential DC voltage between the positive DC voltage terminal and the negative DC voltage terminal exceeding a junction threshold voltage, the differential DC voltage received from the power rails.

17. The method of claim 16, wherein:
the first surge arrester includes a first continuous operating voltage and a first peak voltage, the first peak voltage being a maximum voltage the first surge arrester is capable of tolerating for a first time interval,
the second surge arrester includes a second continuous operating voltage and a second peak voltage, the second peak voltage being a maximum voltage the second surge arrester is capable of tolerating for a second time interval, and
the first continuous operating voltage and the second continuous operating voltage are determined based on an operational voltage of the energy transfer system.

18. The method of claim 17, wherein the energy transfer system comprises a plurality of inverters of a same type having insulated gate bipolar transistor (IGBT)-based circuits having a plurality of IGBTs.

19. The method of claim 18, wherein:
the first peak voltage and the second peak voltage are determined based on an insulation threshold voltage of an IGBT, the insulation threshold voltage being a voltage above which causing damages to the IGBT, and
the junction threshold voltage is set based on a breakdown voltage of a PN junction of an IGBT and is lower than the breakdown voltage.

20. The method of claim 16, wherein the chopper controller is an analog comparator.
